(19) United States
(12) Patent Application Publication
(10) Pub. No.: US 2014/0125596 A1
(43) Pub. Date: May 8, 2014

(54) Method of Inputting Characters, and Apparatus and System for Inputting Characters Using The Method

(71) Applicant: Chan Bong Park, Gyeonggi-do (KR)

(72) Inventor: Chan Bong Park, Gyeonggi-do (KR)

(21) Appl. No.: 13/984,224

(22) PCT Filed: Apr. 4, 2012
(86) PCT No.: PCT/KR2012/002501

§ 371 Date: Aug. 7, 2013

(30) Foreign Application Priority Data
Apr. 4, 2011 (KR) 10-2011-0030718

(51) Int. Cl. G06F 3/023; G06F 3/01

(52) U.S. Cl. CPC G06F 3/0236; G06F 3/014
USPC 345/169

(57) ABSTRACT

A character inputting method and a character inputting apparatus using the method. The method includes: providing first through fifth sensors connected to a left hand of a user and sixth through tenth sensors connected to a right hand of the user; receiving a first signal generated from one of the first through fifth sensors; receiving a second signal generated from one of the sixth through tenth sensors; combining the first signal and the second signal; and outputting a key value corresponding to the combination of the first and second signals, wherein the first signal has one of five different values, and the second signal has one of five different values, and the first signal and the second signal have different values.

### TECHNICAL FIELD

The present invention relates to a method of inputting characters, and an apparatus and system for inputting characters using the method, and more particularly, to a method of inputting characters in which key values may be input without a keyboard, and an apparatus and system for inputting characters using the method.

### BACKGROUND ART

An electronic device typically includes an inputting apparatus, and particularly in electronic devices requiring character input such as computers, laptop computers, and mobile phones, various forms of keypads or keyboards are included. Recently, as the electronic devices are being reduced in size, research into inputting apparatuses using a virtual keyboard inputting method without a keyboard but allowing the same inputting as when using a keyboard has been vigorously conducted. In addition, a method and apparatus for inputting characters while performing other tasks is in request.

### DISCLOSURE

### Technical Problem

The present invention provides a method of inputting characters which is easy to use.

The present invention also provides an apparatus and system for inputting characters which uses an inputting method which is easy to use, and whereby user activities are not limited.

### Technical Solution

According to an aspect of the present invention, there is provided a method of inputting characters, the method comprising: providing first through fifth sensors connected to a left hand of a user and sixth through tenth sensors connected to a right hand of the user; receiving a first signal generated from one of the first through fifth sensors; receiving a second signal generated from one of the sixth through tenth sensors; combining the first signal and the second signal; and outputting a key value corresponding to the combination of the first and second signals, wherein the first signal has one of five different values, and the second signal has one of five different values, and the first signal and the second signal have different values.

The outputting a key value may comprise determining a key value, wherein if the first signal is generated before the second signal, determining a character row by the first signal and determining one of keys included in the character row; and if the second signal is generated before the first signal, determining a character raw by the second signal, and determining one of keys included in the character row.

The character row may comprise: input character rows corresponding to first through fourth rows on the right side that are input by the right hand of the user and first through fourth rows on the left that are input by the left hand of the user on a QWERTY keyboard; and a special key row including a first special key row and a second special key row, wherein the first special key row and the second special key row comprise ten special keys selected from the group consisting of direction keys such as ‘←’, ‘↓’, ‘→’, and ‘↑’, function keys such as ‘F1’ and ‘F2’, special character keys such as ‘+’ and ‘[’, and special keys including ‘space’, ‘enter’, ‘KOR/ENG’, ‘back’, ‘shift’, ‘alt’, and ‘ctrl’.

The first through fifth sensors may sequentially correspond from the little finger to the thumb of the left hand, and the sixth through tenth sensors may sequentially correspond from the thumb to the little finger of the right hand, and one of the first through fourth rows on the right and the first special key row may be selected as the character row by the first signal generated from the first through fifth sensors respectively or one of the first through fourth rows on the left and the second special key row may be selected as the character row by the second signal generated from the sixth through tenth sensors respectively, and if the character row is determined by the first signal, the key may be determined by the second signal generated by one of the sixth through tenth sensors of the fingers sequentially corresponding from the left side to the right side in the character row according to an arrangement sequence of the QWERTY keyboard, and if the character row is determined by the second signal, the key may be determined by the first signal generated by one of the first through fifth sensors of the fingers sequentially corresponding from the left side to the right side in the character row according to the arrangement sequence of the QWERTY keyboard.

The outputting a key value may comprise converting the key value into a voice and outputting the voice.

According to another aspect of the present invention, there is provided a character inputting apparatus comprising: a first sensor set comprising first through fifth sensors connected to a left hand of a user; a second sensor set comprising sixth through tenth sensors connected to a right hand of the user; and a key outputting unit receiving the first signal generated from one of the sensors of the first sensor set and the second signal generated from one of the sensors of the second sensor set and outputting a key value corresponding to a combination of the first signal and the second signal, wherein the first signal has one of five different values, and the second signal has one of five different values, and the first and second signals have different values.

The first through fifth sensors may sequentially correspond from the little finger to the thumb of the left hand, and the sixth through tenth sensors may sequentially correspond from the thumb to the little finger of the right hand, and the key value may comprise: forty character key values according to a combination of the first signal generated first from the first through fourth sensors and the second signal generated after from the sixth through tenth sensors and a combination of the second signal generated first from the sixth through ninth sensors and the first signal generated after from the first through fifth sensors; and ten special key values according to a combination of the first signal generated first from the fifth sensor and the second signal generated after from the sixth through tenth sensors and a combination of the second signal generated first from the tenth sensor and the first signal generated after from the first through fifth sensors.

When the first signal is generated before the second signal, a character row is selected from among first through fourth rows on the right side input by the right hand of the user on the QWERTY keyboard and the first special key row by using the first through fifth sensors respectively corresponding to the rows, and one of the keys is selected by using the sixth through tenth sensors corresponding to the keys of the character row according to an arrangement sequence from the left to the right of the QWERTY keyboard, and when the second signal is generated before the first signal, a character row is selected from among first through fourth rows on the left side input by the left hand of the user on the QWERTY keyboard and the second special key row, and one of the keys is selected by the first through fifth sensors corresponding to the keys of the character row according to an arrangement sequence from the left to the right of the QWERTY keyboard, and the first special key row and the second special key row comprise ten special keys selected from the group comprising direction keys ‘←’, ‘↓’, ‘→’, and ‘↑’, function keys such as ‘F1’? and ‘F2’, special character keys ‘+’ and ‘[’, and special keys such as ‘space’, ‘enter’, ‘KOR/ENG’, ‘back’, ‘shift’, ‘alt’, and ‘ctrl’.

The sensors of the first sensor set and the sensors of the second sensor set may be wearable on fingers of the user.

The character inputting apparatus may further comprise a mounting unit comprising one of a magnet, Velcro, and zipper to install the character inputting apparatus to one of clothing, personal effects, and accessories.

The character inputting apparatus may further comprise: a power unit that supplies power to the sensors of the first sensor set, the sensors of the second sensor set, and the key outputting unit; a voice outputting unit converting the key value into a voice and outputting the voice; and a signal transmitting/receiving unit transmitting or receiving the first signal, the second signal, and the key value output from the key outputting unit by using a wireless communication method.

According to another aspect of the present invention, there is provided a character inputting system comprising: a character inputting apparatus described above; a display device that displays the key value output from the character inputting apparatus; and a computing device that processes the key value output from the character inputting apparatus.

The sensors of the first sensor set and the sensors of the second sensor set may be combined with the display device or the computing device.

### Advantageous Effects

According to the method of inputting characters of the embodiments of the present invention, a key value determining method corresponding to an arrangement of a typical keyboard is used, thereby increasing user convenience.

According to the apparatus and system for inputting characters of the embodiments of the present invention, characters are input using connection sensors connected to fingers, and thus characters may be input without spatial restriction and without limiting user activity. In addition, as the key value determining method corresponding to an arrangement of a typical keyboard is used by the apparatus and system for inputting characters, user convenience may be improved.

### DESCRIPTION OF DRAWINGS

The above and other features and advantages of the present invention will become more apparent by describing in detail exemplary embodiments thereof with reference to the attached drawings in which:

FIG. 1 is a block diagram illustrating a character inputting apparatus according to an embodiment of the present invention;

FIG. 2 is a block diagram illustrating a character inputting system including the character inputting apparatus according to an embodiment of the present invention;

FIGS. 3a through 3c are schematic views illustrating a character inputting apparatus according to embodiments of the present invention;

FIG. 4 is a schematic view illustrating a QWERTY keyboard for explaining a method of determining key values in a method of inputting characters according to an embodiment of the present invention;

FIG. 5a is a flowchart illustrating a method of inputting characters according to an embodiment of the present invention;

FIG. 5b is a flowchart illustrating a method of determining key values in the method of inputting characters according to an embodiment of the present invention; and

FIG. 6 is a front view of a mobile electronic device in which a method of inputting characters according to an embodiment of the present invention is used.

### MODE FOR INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. Like reference numerals denote like elements. Furthermore, various elements and regions in the drawings are schematically illustrated. Accordingly, the present invention is not limited to relative sizes or intervals illustrated in the attached drawings. As used herein, the term “and/or” includes any and all combinations of one or more of the associated listed items.

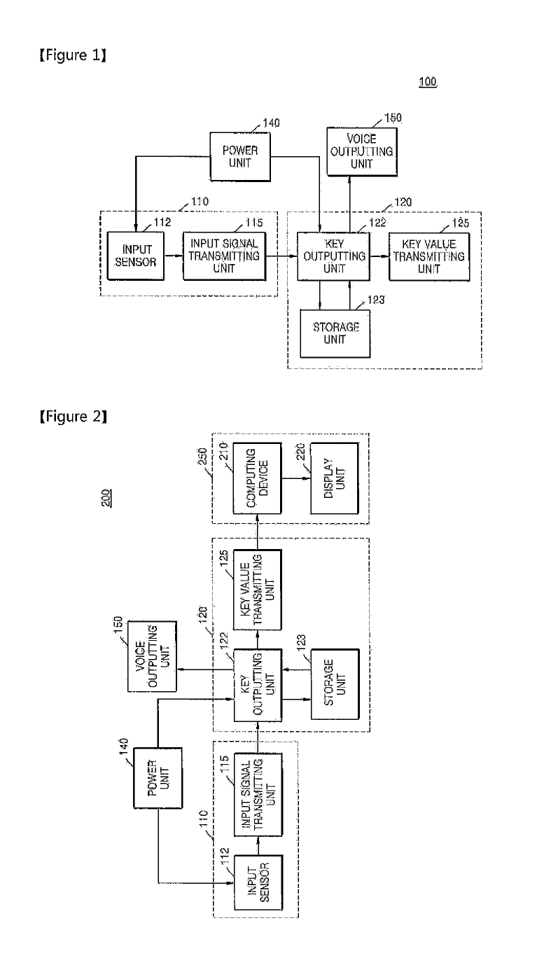

FIG. 1 is a block diagram illustrating a character inputting apparatus 100 according to an embodiment of the present invention.

Referring to FIG. 1, the character inputting apparatus 100 may include an inputting unit 110, a processing unit 120, a power unit 140, and a voice outputting unit 150. The inputting unit 110 may include an input sensor 112 and an input signal transmitting unit 115, and the processing unit 120 may include a key outputting unit 122, a storage unit 123, and a key value transmitting/receiving unit 125. The character inputting apparatus 100 may use a virtual keyboard to input characters. In other words, a keyboard is not provided but inputting may be performed via the inputting unit 110.

The input sensor 112 generates an input signal by sensing contacts of the fingers of a user and may be connected to each finger tip. The input sensor 112 may generate a signal when the fingers of a user contact a predetermined surface. The input sensor 112 may be, for example, a thin film-type sensor, or may include an electrical or mechanical sensor. For example, the input sensor 112 may include a piezoelectric material which is capable of generating an electrical signal by a contact pressure of the fingers. In this specification, a signal generated by the fingers of a left hand of the user will be referred to as a first signal, and a signal generated by the fingers of a right hand of the user will be referred to as a second signal. To input characters, a first signal and a second signal may be generated from the input sensor 112.

The input signal transmitting unit 115 may transmit the first signal or the second signal from the input sensor 112 to the key outputting unit 122. Signals may be transmitted in a wired or wireless transmission method. In a wired transmission method, a signal may be transmitted via a wire. Examples of the wireless transmission method may include a radio frequency identification (RFID) method, a Bluetooth method, a HomeRF method, an infrared data association (IrDA) method, and a ZigBee method.

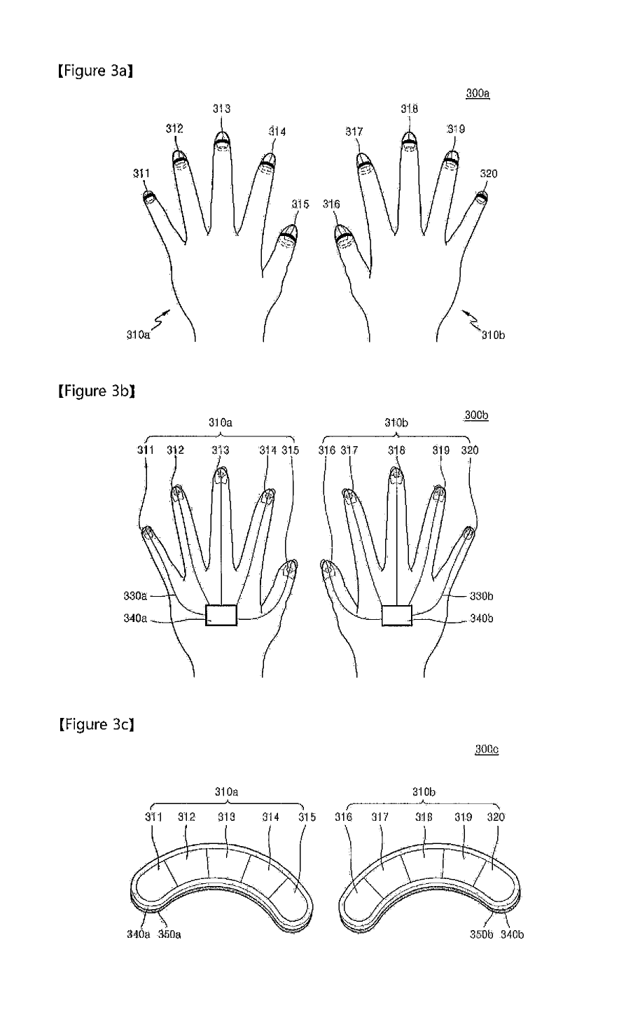

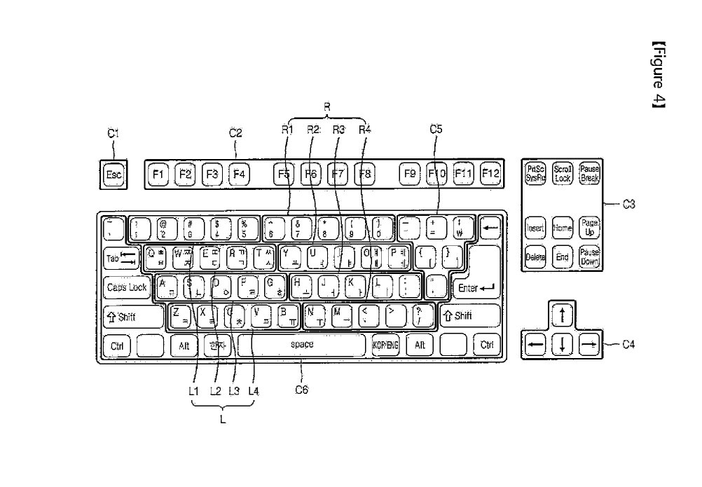

The structure and operation of the inputting unit 110 including the input sensor 112 and the input signal transmitting unit 115 will be described below in detail with reference to FIGS. 3a and 3b.

The key outputting unit 122 may receive from the input sensor 112 an input signal including the first signal and the second signal, and output a predetermined key value. The key outputting unit 122 may output a key value corresponding to the input signal from data that is stored in advance in the storage unit 123 based on the received input signal. In the storage unit 123, key values corresponding to combinations of the first signal and the second signal are stored in advance, thereby providing data about the corresponding key value to the key outputting unit 122. A method of determining key values corresponding to the combinations of the first signal and the second signal will be described in detail with reference to FIG. 4.

The key value transmitting/receiving unit 125 may transmit a key value output from the key outputting unit 122 to a computing device (not shown) such as a terminal. In addition, the key value transmitting/receiving unit 125 may receive data for setting up a new key value from the computing device. Signals may be transmitted or received via a wired or wireless transmission method. Examples of the wired transmission method include a PS/2 or universal serial bus (USB) method, and examples of the wireless transmission method include an RFID method, a Bluetooth method, a HomeRF method, an IrDA method, and a ZigBee method. The computing device may be, for example, an electric device such as a computer or a laptop computer, an imaging device such as TV, or a mobile device such as a portable game console or mobile phone.

The power unit 140 may supply power to the input sensor 112 and/or the key outputting unit 122. Power supplied to the input sensor 112 and/or the key outputting unit 122 may be transmitted to the input signal transmitting unit 115 and the key value transmitting/receiving unit 125. Power supply is not limited as indicated by the arrows shown in FIG. 1, and the power unit 140 may supply power to the entire character inputting apparatus 100.

The voice outputting unit 150 may convert a key value output from the key outputting unit 122 into a voice and output the same. The voice outputting unit 150 may perform functions of converting a key value into a voice and transmitting the voice. For example, the voice outputting unit 150 may be in the form of an earphone or a headphone to transmit an output key value to a user in real-time as a voice. The voice outputting unit 150 may be set to continuously output an input key value or, if a character is formed by key values input one after the other, to output the character as a voice. If word spacing is conducted by a signal input by the user, the voice outputting unit 150 may be set to output a word formed by key values input before the word spacing.

FIG. 2 is a block diagram illustrating a character inputting system 200 including the character inputting apparatus 100 according to an embodiment of the present invention. In FIG. 2, like reference numerals denote like elements, and thus repeated descriptions are omitted.

Referring to FIG. 2, the character inputting system 200 may include a character inputting apparatus 100 and a computing system 250. The computing system 250 may include a computing apparatus 210 and a display unit 220.

The computing apparatus 210 processes a key value output from the character inputting apparatus 100. The computing apparatus 210 may be, for example, one of a computer, a laptop computer, a TV, a portable game console, a personal digital assistant (PDA), and a mobile phone. The computing device 210 may display the key value via the display unit 220 or may store the key value in an internal memory. In addition, the display unit 220 may include a display panel for displaying the key value.

The user may set key values stored in the storage unit 123 by using an exclusive program installed in the computing device 210. For example, the user may reset all or some key values corresponding to combinations of the first signal and the second signal.

Although not shown in FIG. 2, according to another embodiment of the present invention, the processing unit 120, including the key outputting unit 122 and the storage unit 123, may be included in the computing device 210. In this case, a signal generated by the input sensor 112 may be transmitted directly to the computing device 210 via the input signal transmitting unit 115, and a predetermined key value may be output via the key outputting unit 122.

According to the character inputting system 200 according to the current embodiment of the present invention, even when a user is far from an electronic device corresponding to the computing device 210, characters may be input as desired, and additional space for inputting characters is not required.

FIGS. 3a through 3c are schematic views illustrating a portion of a character inputting apparatus 300a and 300b according to embodiments of the present invention.

Referring to FIGS. 3a through 3c, the character inputting apparatuses 300a through 300c each include a first sensor set 310a connected to a left hand of a user and a second sensor set 310b connected to a right hand of a user.

In the first sensor set 310a, first through fifth sensors 311, 312, 313, 314, and 315 may be sequentially connected from the little finger to the thumb of the left hand. In the second sensor set 310b, sixth through tenth sensors 316, 317, 318, 319, and 320 may be sequentially connected from the thumb to the little finger of the right hand.

When one of the first through fifth sensors 311, 312, 313, 314, and 315 of the first sensor set 310a contacts a predetermined surface, a first signal may be generated. The first signal may have different values according to the first through fifth sensors 311, 312, 313, 314, and 315 of the first sensor set 310a. When one of the sixth through tenth sensors 316, 317, 318, 319, and 320 of the second sensor set 310b contacts a predetermined surface, a second signal may be generated. The second signal may have different values according to the sixth through tenth sensors 316, 317, 318, 319, and 320 of the second sensor set 310b, and may be different from a value generated by the first signal from the first sensor set 310a.

For example, the first signal from the first through fifth sensors 311, 312, 313, 314, and 315 of the first sensor set 310a may have values of 1, 2, 3, 4, and 5. Also, the second signal from the sixth through tenth sensors 316, 317, 318, 319, and 320 of the second sensor set 310b may have values of 6, 7, 8, 9, and 0.

The first signal generated from the first sensor set 310a and the second signal generated from the second sensor set 310b may be transmitted to the key outputting unit 122 via the input signal transmitting unit 115 described above with reference to FIGS. 1 and 2.

In the embodiment of FIG. 3a, the input signal transmitting unit 115 may be connected to each of the first through tenth sensors 311 through 320. That is, the first through tenth sensors 311 through 320 as a whole may form the single input unit 110 (refer to FIGS. 1 and 2). Accordingly, via the input signal transmitting unit 115 disposed at a portion of each of the first through tenth sensors 311 through 322 in the form of a band or a ring, an input signal may be transmitted to an additional key outputting unit (not shown). The first through tenth sensors 311 through 320 may also each include the power unit 140 (see FIGS. 1 and 2).

Referring to FIG. 3b, the first through tenth sensors 311 through 320 may be connected to processing units 340a and 340b via input signal transmitting units 330a and 330b in the form of conductive lines. The processing units 340a and 340b may each include all of the key outputting unit 122, the storage unit 123, and the key value transmitting/receiving unit 125 described above with reference to FIGS. 1 and 2. The processing units 340a and 340b may each include the power unit 140 (see FIGS. 1 and 2).

The first sensor set 310a and the second sensor set 310b may be worn on the hands of the user. For example, the first sensor set 310a and the second sensor set 310b may be in the form of bands. Alternatively, the first sensor set 310a and the second sensor set 310b may be manufactured in the form of gloves. That is, the first sensor set 310a and the second sensor set 310b may be in the form of bands or gloves where the first through tenth sensors 311 through 320 are arranged on bottom surfaces of the fingers of the user. In the character inputting apparatus 300b of FIG. 3b, all of the first through tenth sensors 311 through 320, the signal transmitting unit 330a and 330b, and the processing unit 340a and 340b may be formed in the form of wearable gloves.

According to the embodiments of FIGS. 3a and 3b, the first through tenth sensors 311 through 320 may be arranged on the fingers of the user, respectively. Thus, user activity is not limited, and characters may be input simply by the fingers contacting a predetermined surface.

According to the embodiment of FIG. 3c, a character inputting apparatus 300c may include a first sensor set 310a and a second sensor set 310b in the form of panels. Operations of the first through tenth sensors 311 through 320 and the processing units 340a and 340b may be the same as those in the above-described character inputting apparatuses 300a and 300b. The first through tenth sensors 311 through 320 may be connected to the input signal transmitting unit 115, and the processing units 340a and 340b may each include the power unit 140 (see FIGS. 1 and 2).

The character inputting apparatus 300c in the form of a panel may further include additional mounting units 350a and 350b. The mounting units 350a and 350b may perform the function of attaching the character inputting apparatus 300c to a portable product or accessory such as clothes, bags, or hats for user convenience. The mounting units 350a and 350b may include an attaching unit such as a magnet, Velcro, or zipper. For example, if the mounting units 350a and 350b include Velcro, the mounting units 350a and 350b may be attached on pants, gloves, or hats such that the user may easily use the character inputting apparatus 300c even when the user is performing other activities.

FIG. 4 is a schematic view illustrating a QWERTY keyboard for explaining a method of determining a key value in a method of inputting characters according to an embodiment of the present invention.

FIG. 4 illustrates a portion of a QWERTY keyboard. The QWERTY keyboard is an English keyboard arrangement in which six English keys in the top left letter row are Q W, E, R, T, and Y from left to right. For convenience of description, keys of the QWERTY keyboard are divided into character keys (L, R) and special keys (C1 through C6). The character keys (L, R) include left keys (L) that are typically input by the left hand of the user and right keys (R) that are typically input by the right hand of the user. The left keys (L) include first through fourth rows (L1-L4) which are character rows sequentially arranged from the top, and the right keys (R) include first through fourth rows (R1-R4) which are character rows sequentially arranged from the top. The special keys (C1-C6) refer to the rest of keys besides the character keys (L, R), and may include direction keys ‘←’, ‘↓’, ‘→’, and ‘↑’, (C4), function keys such as ‘F1’? and ‘F2’? (C2), special character keys ‘+’ and ‘[’ (C5), and keys such as ‘space’, ‘enter’, ‘KOR/ENG’ (‘Korean/English’), ‘back’, ‘shift’, ‘alt’, and ‘ctrl’ (C6). A method of determining key values in the method of inputting characters according to the current embodiment of the present invention in regard to the keyboard arrangement of the QWERTY keyboard will be described below.

In the current embodiment, key values will be described in a case where the first signal from the first through fifth sensors 311, 312, 313, 314, and 315 of the first sensor set 310a may have values of 1, 2, 3, 4, and 5, and the second signal from the sixth through tenth sensors 316, 317, 318, 319, and 320 of the second sensor set 310b may have values of 6, 7, 8, 9, and 0. When a first signal from the first sensor set 310a of the left hand and a second signal from the second sensor set 310b of the right hand are received, a key value may be determined by combinations of the first signal and the second signal in consideration of the received orders.

Table 1 below shows key values when the first signal is received before the second signal.

Referring to Table 1, the first row shows values of the first signal from the first sensor set 310a of the left hand that are input first, and the first column shows values of the second signal from the second sensor set 310b of the right hand that are input after. One of the first through fourth rows R1-R4 and five keys among the special keys C1-C6 may be activated according to the values of the first signal. According to the subsequent second signal, one of the activated key values may be determined. For example, when a first signal is input from the first sensor 311, one of the key values of the first row R1 on the right side of the QWERTY keyboard may be determined according to the subsequent second signal. When a first signal having a value of 1 is input from the first sensor 311, and a second signal having a value of 6 is input from the sixth sensor 316, ‘6’? may be set as a key value according to Table 1. Also, special key values may be selected by a first signal from the fifth sensor 315. Table 1 shows examples, and any five of the special keys C1-C6 of FIG. 4 may be selected.

By using the first through fifth sensors 311 through 315 that are sequentially connected from the little finger to the thumb of the left hand of the user, the first through fourth rows R1-R4 on the right side of the QWERTY keyboard and a first special key row CC1 of the fifth row of Table 1 may be selected. Also, by using the sixth through tenth sensors 316 through 320 respectively connected from the thumb to the little finger of the right hand of the user, one of the corresponding keys to the arrangement order of the QWERTY keyboard may be determined.

TABLE 1

| | 1 | 2 | 3 | 4 | 5 |
|---|---|---|---|---|---|
| 6 | 6 | y/ [symbol] | h/⊥ | n/τ | space |
| 7 | 7 | u/ [symbol] | j/ [symbol] | m/— | Kor/Eng |
| 8 | 8 | i/ [symbol] | k/ [symbol] | , | Alt |
| 9 | 9 | o/ [symbol] | l/┐ | . | Ctrl |
| 0 | 0 | p/ [symbol] | ; | / | Shift |
| Character | R1 | R2 | R3 | R4 | CC1 |
| row | | | | | |

Table 2 below shows key values in a case where a second signal is received before a first signal.

Referring to Table 2, the first row shows values of the second signal from the second sensor set 310b of the right hand that are input first, and the first column shows values of the first signal from the first sensor set 310b of the left hand that are input after. One of the first through fourth rows L1-L4 or five keys among the special keys C1-C6 may be activated according to the values of the second signal. According to the subsequent first signal, one of the activated key values may be determined. For example, when a second signal is input from the sixth sensor 316, one of the key values of the first row L1 on the left side of the QWERTY keyboard may be determined according to the subsequent first signal. For example, when a second signal having a value of 7 is input from the seventh sensor 317, and a first signal having a value of 2 is input from the seventh sensor 317, ‘w’ or ‘ [symbol] ’ may be set as a key value according to Table 2. Also, special key values may be selected by a second signal from the tenth sensor 320. Table 2 shows examples, and any five of the special keys C1-C6 of FIG. 4 may be selected.

By using the sixth through tenth sensors 316 through 320 that are sequentially connected from the thumb to the little finger of the right hand of the user, the first through fourth rows L1-L4 on the left side of the QWERTY keyboard and a second special key row CC2 of the fifth row of Table 2 may be selected. Also, by using the first through fifth sensors 311 through 315 respectively connected from the little finger to the thumb of the left hand of the use one of keys corresponding to the arrangement order of the QWERTY keyboard may be determined.

TABLE 2

| | 6 | 7 | 8 | 9 | 0 |
|---|---|---|---|---|---|
| 1 | 1 | q/ [symbol] | a/ [symbol] | z/ [symbol] | Tap |
| 2 | 2 | w/ [symbol] | s/ [symbol] | x/ [symbol] | ← |
| 3 | 3 | e/ [symbol] | d/ [symbol] | c/ [symbol] | ↓ |
| 4 | 4 | r/ [symbol] | f/ [symbol] | v/ [symbol] | → |
| 5 | 5 | t/ [symbol] | g/ [symbol] | b/ [symbol] | ↑ |
| Character | L1 | L2 | L3 | L4 | CC2 |
| row | | | | | |

According to another embodiment of the present invention, by using the sixth through tenth sensors 316 through 320 respectively connected from the thumb to the little finger of the right hand of the user, sequentially the second special key row CC2 shown in the fifth row of Table 2 and the fourth through first rows L4-L1 of the left side of the QWERTY keyboard may be selected. That is, unlike in the embodiment described above, the left hand and the right hand of the user may symmetrically correspond to the character rows of the QWERTY keyboard.

As described above, key values from the character inputting apparatus of the current embodiment of the present invention may be determined in accordance with the keyboard arrangement of the QWERTY keyboard. In addition, the key values may also be determined in accordance with any keyboard having different arrangements according to languages. That is, the key values described above are not limited to the current embodiment of the present invention, and may vary according to setups.

According to the method of inputting characters of the current embodiment of the present invention, a character row is selected first by the left hand or the right hand of the user, and then a key is selected from the selected character row by the other not used to select the first selected character row. In addition, a key value is determined by combinations of the character row and the key so as to sequentially correspond to the keyboard arrangement of the keyboard used in general. Accordingly, the user may easily use the character inputting apparatus simply by remembering a keyboard arrangement that is familiar to a user.

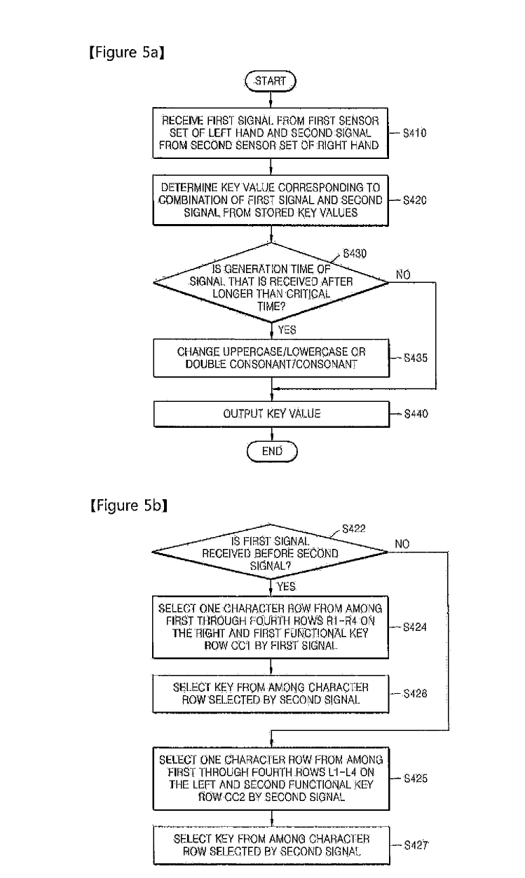

FIG. 5a is a flowchart illustrating a method of inputting characters, according to an embodiment of the present invention, and FIG. 5b is a flowchart illustrating a method of determining key values in the method of inputting characters, according to an embodiment of the present invention.

Referring to FIGS. 5a and 1, first, in operation S410, a first signal from the first sensor set 310a of FIGS. 3a and 3b and a second signal from the second sensor set 310b may be received. In this operation, the first signal and the second signal generated by the input sensor 112 connected to the fingers of the user are received; in detail, one of the first signal and the second signal is first received, and then the other signal is received thereafter.

Next, in operation S420, a key value corresponding to a combination of the first signal and the second signal may be determined from among stored key values. The key values may be stored in the additional storage unit 123 or in the key outputting unit 122 according to a modified example. In this operation, the combination of the first signal and the second signal refers to a pair of signal values in consideration of a sequence of received signals. One of a total of fifty key values may be determined by the combination of five different first signals and five different second signals. The operation of determining a key value corresponding to the combinations of the first signal and the second signal will be described in detail with reference to FIG. 5b.

Next, in operation S430, it may be determined whether a generation time period of a signal received after from among the first signal and the second signal is greater than a critical time period. That is, when the subsequent signal, whereby the user determines a key value from a character row, is input, and this signal is generated by contacting an input sensor for a longer period of time than the critical time period, lowercase in English may be converted to uppercase, or a consonant in Korean may be converted to a double consonant in operation S435. This operation is performed in order to allow easy conversion between lowercase and uppercase or between consonants and double consonants without using a “Shift”? key, which is set as a special key value.

Next, in operation S440, the determined key value may be output. The key value determined in operation S420 or the modified key value modified in operation S435 may be output by using the key outputting unit 122. In this operation, the output key value may be converted into a voice and output. The key value may be consecutively output or when a character is formed by the first input key value and the subsequently input key value, the character may be output. When word spacing is performed by a signal input by the user, a word formed by key values that are input before the word spacing may be output as a voice.

The above-described operations of inputting characters may be repeated several times. When the character inputting operation is performed once, for example, an operation of inputting a character such as ‘┐’, ‘ [symbol] ’, ‘a’, or ‘e’ or a function such as word spacing may be performed.

Referring to FIG. 5b, operation S420 in FIG. 5a of determining a key value will be described in detail. In operation S422, it may be determined which of the received first and second signals has been received first.

Next, if a first signal is received first, one of the character rows among the first through fourth rows R1 through R4 on the right side and the first special key row CC1 as shown in the fifth row of Table 1 may be selected in operation S424. Next, a key from among the character row selected by the second signal received after may be selected to thereby determine a key value in operation S426.

If a second signal is received first, one of the character rows among the first through fourth rows L1 through L4 on the left side and the second special key row CC2 as shown in the fifth row of Table 2 may be selected in operation S425. Next, a key from among the character row selected by the first signal received after may be selected to thereby determine a key value in operation S427.

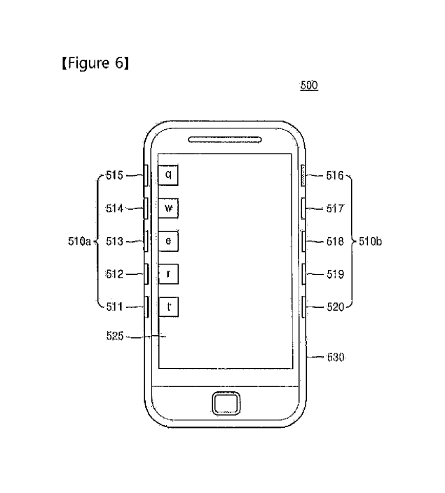

FIG. 6 is a front view of a mobile electronic device 500 in which a method of inputting characters according to an embodiment of the present invention is used.

Referring to FIG. 6, the mobile electronic device 500 may include input sensors 511 through 520, a display unit 525, and a body unit 530.

The input sensors 511 through 520 may include a first sensor set 510a and a second sensor set 510b. The input sensors 511 through 520 may be formed as buttons, and a signal may be generated by the user pressing the buttons with a predetermined pressure. Alternatively, the input sensors 511 through 520 may be generated by a contact made by the user. The form and arrangement of the input sensors 511 through 520 are not limited to FIG. 6. For example, the input sensors 511 through 520 may be all arranged on a side of the mobile electronic device 500. In addition, alternatively, the input sensors 511 through 520 may be integrated with the display unit 525 to be implemented as a touch panel.

In the first sensor set 510a, the first through fifth sensors 511 through 515 may correspond to the fingers of the left hand. In the second sensor set 510b, the sixth through tenth sensors 516 through 520 may correspond to the fingers of the right hand.

A first signal may be generated by pressing or contacting one of the first through fifth sensors 511 through 515 of the first sensor set 510a. The first signal may have different values according to the first through fifth sensors 511 through 515 of the first sensor set 510a. A second signal may be generated by pressing or contacting one of the sixth through tenth sensors 516 through 520 of the second sensor set 510b. The second signal may have different values according to the sixth through tenth sensors 516 through 520 of the second sensor set 510b, and may also be different from a value of the first signal from the first sensor set 510a.

When one of the first and second signals is first input via a display screen, the display unit 525 may be controlled to display a character row selected by the inputting. For example, in the setup of the key values as described above with reference to FIG. 4, if a second signal is input first from the sixth sensor 516, key values such as ‘q’, ‘w’, ‘e’, ‘r,’ and ‘t’ of the first row L1 on the left may be displayed on the display unit 525. Accordingly, the user may select one of the displayed key values of the first row L1 on the left via the first sensor set 510a, thereby simplifying input characters.

The body unit 530 may include the key outputting unit 122 and the storage unit 123 of FIGS. 1 and 2.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of inputting characters, the method comprising:
providing first through fifth sensors connected to a left hand of a user and sixth through tenth sensors connected to a right hand of the user;
receiving a first signal generated from one of the first through fifth sensors;
receiving a second signal generated from one of the sixth through tenth sensors;
combining the first signal and the second signal; and
outputting a key value corresponding to the combination of the first and second signals,
wherein the first signal has one of five different values, and the second signal has one of five different values, and the first signal and the second signal have different values.

2. The method of claim 1, wherein the outputting a key value comprises determining a key value,
wherein if the first signal is generated before the second signal, determining a character row by the first signal and determining one of keys included in the character row; and
if the second signal is generated before the first signal, determining a character row by the second signal, and determining one of keys included in the character row.

3. The method of claim 2, wherein the character row comprises: input character rows corresponding to first through fourth rows on the right side that are input by the right hand of the user and first through fourth rows on the left that are input by the left hand of the user on a QWERTY keyboard; and a special key row including a first special key row and a second special key row,
wherein the first special key row and the second special key row comprise ten special keys selected from the group consisting of direction keys such as ‘←’, ‘↓’, ‘→’, and ‘↑’, function keys such as ‘F1’ and ‘F2’, special character keys such as ‘+’ and ‘[’, and special keys including ‘space’, ‘enter’, ‘KOR/ENG’, ‘back’, ‘shift’, ‘alt’, and ‘ctrl’.

4. The method of claim 3, wherein the first through fifth sensors sequentially correspond from the little finger to the thumb of the left hand, and the sixth through tenth sensors sequentially correspond from the thumb to the little finger of the right hand, and
one of the first through fourth rows on the right and the first special key row is selected as the character row by the first signal generated from the first through fifth sensors respectively or one of the first through fourth rows on the left and the second special key row is selected as the character row by the second signal generated from the sixth through tenth sensors respectively, and
if the character row is determined by the first signal, the key is determined by the second signal generated by one of the sixth through tenth sensors of the fingers sequentially corresponding from the left side to the right side in the character row according to an arrangement sequence of the QWERTY keyboard, and if the character row is determined by the second signal, the key is determined by the first signal generated by one of the first through fifth sensors of the fingers sequentially corresponding from the left side to the right side in the character row according to the arrangement sequence of the QWERTY keyboard.

5. The method of claim 1, wherein the outputting a key value comprises converting the key value into a voice and outputting the voice.

6. A character inputting apparatus comprising:
a first sensor set comprising first through fifth sensors connected to a left hand of a user;
a second sensor set comprising sixth through tenth sensors connected to a right hand of the user; and
a key outputting unit receiving the first signal generated from one of the sensors of the first sensor set and the second signal generated from one of the sensors of the second sensor set and outputting a key value corresponding to a combination of the first signal and the second signal,
wherein the first signal has one of five different values, and the second signal has one of five different values, and the first and second signals have different values.

7. The character inputting apparatus of claim 6, wherein the first through fifth sensors sequentially correspond from the little finger to the thumb of the left hand, and the sixth through tenth sensors sequentially correspond from the thumb to the little finger of the right hand, and
the key value comprises:
forty character key values according to a combination of the first signal generated first from the first through fourth sensors and the second signal generated after from the sixth through tenth sensors and a combination of the second signal generated first from the sixth through ninth sensors and the first signal generated after from the first through fifth sensors; and
ten special key values according to a combination of the first signal generated first from the fifth sensor and the second signal generated after from the sixth through tenth sensors and a combination of the second signal generated first from the tenth sensor and the first signal generated after from the first through fifth sensors.

8. The character inputting apparatus of claim 7, wherein when the first signal is generated before the second signal, a character row is selected from among first through fourth rows on the right side input by the right hand of the user on the QWERTY keyboard and the first special key row by using the first through fifth sensors respectively corresponding to the rows, and one of the keys is selected by using the sixth through tenth sensors corresponding to the keys of the character row according to an arrangement sequence from the left to the right of the QWERTY keyboard, and
when the second signal is generated before the first signal, a character row is selected from among first through fourth rows on the left side input by the left hand of the user on the QWERTY keyboard and the second special key row, and one of the keys is selected by the first through fifth sensors corresponding to the keys of the character row according to an arrangement sequence from the left to the right of the QWERTY keyboard, and
the first special key row and the second special key row comprise ten special keys selected from the group comprising direction keys ‘←’, ‘↓’, ‘→’,and ‘↑’, function keys such as ‘F1’? and ‘F2’, special character keys ‘+’ and ‘[’, and special keys such as ‘space’, ‘enter’, ‘KOR/ENG’, ‘back’, ‘shift’, ‘alt’, and ‘ctrl’.

9. The character inputting apparatus of claim 6, wherein the sensors of the first sensor set and the sensors of the second sensor set are wearable on fingers of the user.

10. The character inputting apparatus of claim 6, further comprising a mounting unit comprising one of a magnet, Velcro, and zipper to install the character inputting apparatus to one of clothing, personal effects, and accessories.

11. The character inputting apparatus of claim 6, further comprising:
a power unit that supplies power to the sensors of the first sensor set, the sensors of the second sensor set, and the key outputting unit;
a voice outputting unit converting the key value into a voice and outputting the voice; and
a signal transmitting/receiving unit transmitting or receiving the first signal, the second signal, and the key value output from the key outputting unit by using a wireless communication method.

12. A character inputting system comprising:
a character inputting apparatus of claim 6;
a display device that displays the key value output from the character inputting apparatus; and
a computing device that processes the key value output from the character inputting apparatus.

13. The character inputting system of claim 12, wherein the sensors of the first sensor set and the sensors of the second sensor set are combined with the display device or the computing device.
